(19) United States
(12) Patent Application Publication
(10) Pub. No.: US 2018/0067700 A1
(43) Pub. Date: Mar. 8, 2018

(54) INFORMATION PROCESSING DEVICE, COMPUTER-READABLE RECORDING MEDIUM, AND INFORMATION PROCESSING SYSTEM

(71) Applicant: Shigeo ARAKI, Kanagawa (JP)

(72) Inventor: Shigeo ARAKI, Kanagawa (JP)

(21) Appl. No.: 15/556,029

(22) PCT Filed: Mar. 16, 2016
(86) PCT No.: PCT/JP2016/001524

§ 371 Date: Sep. 6, 2017

(30) Foreign Application Priority Data
Mar. 19, 2015 (JP) 2015-056452
Jan. 14, 2016 (JP) 2016-005577

(51) Int. Cl. G06F 3/12

(52) U.S. Cl. CPC G06F 3/1204; G06F 3/1225; G06F 8/61; G06F 3/1288; G06F 3/1287

(57) ABSTRACT

An information processing device that connects to an external device via a network, the information processing device includes: a first connection unit configured to connect to, without the network, a terminal capable of connecting to equipment that executes processing in accordance with a request from the terminal; an acquisition unit configured to acquire a control program for controlling the equipment from the external device via the network; a storage control unit configured to store the control program acquired by the acquisition unit in a predetermined storage area that is recognized as an external storage device by the terminal connected by the first connection unit; and a display control unit configured to display, on a display unit, a utilization screen that prompts reading of the storage area when the information processing device is connected to the terminal by the first connection unit.

### TECHNICAL FIELD

The present invention relates to an information processing device, a computer-readable recording medium, and an information processing system.

### BACKGROUND ART

Conventionally, techniques have been disclosed that readily introduce control programs to client devices. For example, patent literature 1 discloses a technique in which a dedicated program is installed in a client device capable of connecting to an external network and a control program is downloaded from a server via the network and installed by executing the dedicated program.

From the point of view of security and the like, an environment is constructed in which the client device connected to a local network such as an in-house network cannot connect to the external network.

### SUMMARY OF INVENTION

### Technical Problem

Each client device under such an environment cannot download the control program for controlling other equipment such as a printer connected to the local network from an external device via the external network. Conventionally, under an environment in which a terminal such as the client device is not connected to the external network, it is, thus, difficult to readily install the control program for the equipment in the terminal.

### Solution to Problem

According to exemplary embodiments of the present invention, there is provided an information processing device that connects to an external device via a network, the information processing device comprising: a first connection unit configured to connect to, without the network, a terminal capable of connecting to equipment that executes processing in accordance with a request from the terminal; an acquisition unit configured to acquire a control program for controlling the equipment from the external device via the network; a storage control unit configured to store the control program acquired by the acquisition unit in a predetermined storage area that is recognized as an external storage device by the terminal connected by the first connection unit; and a display control unit configured to display, on a display unit, a utilization screen that prompts reading of the storage area when the information processing device is connected to the terminal by the first connection unit.

### Advantageous Effects of Invention

Exemplary embodiments of the invention have an advantageous effect of making it possible to readily install the control program for the equipment in the terminal under the environment in which the terminal is not connected to the external network.

### BRIEF DESCRIPTION OF DRAWINGS

FIG. 1 is a schematic diagram illustrating an example of an information processing system of an embodiment of the present invention.

FIG. 2 is a schematic diagram illustrating an example of a hardware structure of a client device, an information processing device, and the external device in the embodiment.

FIG. 3 is a functional block diagram of the information processing device.

FIG. 4 is a schematic diagram illustrating an example of an equipment selection screen.

FIG. 5A is a schematic diagram illustrating an example of a utilization screen.

FIG. 5B is a schematic diagram illustrating an example of a utilization screen.

FIG. 6 is a schematic diagram illustrating an example of a data structure of a storage area.

FIG. 7 is a functional block diagram of the client device.

FIG. 8 is a sequence diagram illustrating an exemplary procedure of information processing executed by the information processing system.

FIG. 9 is a schematic diagram illustrating another example of the data structure of the storage area.

FIG. 10 is a sequence diagram illustrating an exemplary procedure of the information processing.

FIG. 11 is a flowchart illustrating an exemplary procedure of installation processing.

FIG. 12 is a functional block diagram of another example of the information processing device.

FIG. 13 is a schematic diagram illustrating another example of the equipment selection screen.

FIG. 14 is a schematic diagram illustrating an example of a setting screen.

FIG. 15 is a schematic diagram illustrating another example of the setting screen.

FIG. 16 is a schematic diagram illustrating an example of a first file.

FIG. 17 is a schematic diagram illustrating an example of a second file.

FIG. 18 is a schematic diagram illustrating another example of the data structure of the storage area.

FIG. 19 is a functional block diagram of another example of the client device.

FIG. 20 is a sequence diagram illustrating another exemplary procedure of the information processing.

FIG. 21 is a schematic diagram illustrating another example of the data structure of the storage area.

FIG. 22 is a functional block diagram of another example of the client device.

FIG. 23 is a sequence diagram illustrating another exemplary procedure of the information processing.

### DESCRIPTION OF EMBODIMENTS

The following describes an embodiment of an information processing device, a computer-readable recording medium having a computer program, and an information processing system in detail with reference to the accompanying drawings.

### First Embodiment

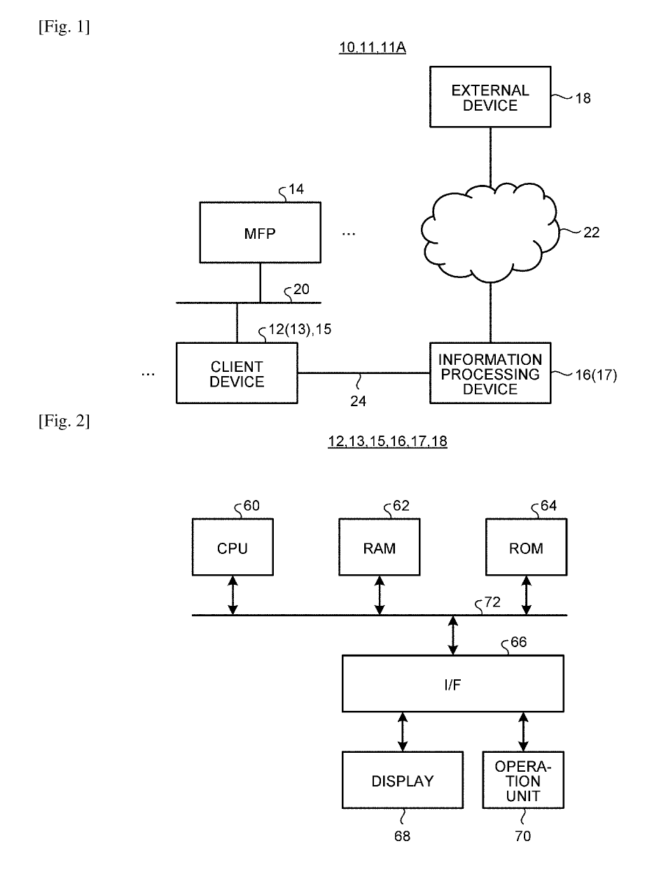

FIG. 1 is a schematic diagram illustrating an example of an information processing system 10.

The information processing system 10 includes a client device 12 and an information processing device 16. The client device 12 corresponds to the terminal in the present invention.

The client device 12 is a known personal computer, for example. The client device 12 is connected to equipment such as a multifunction peripheral (MFP) 14 via a first network 20.

The first network 20 is a local area network such as an in-house local area network (LAN). Each equipment (the client device 12 and the MFP 14) connected to the first network 20 communicates in accordance with a known protocol such as TCP/IP.

To the first network 20, one or multiple client devices 12 and one or multiple pieces of equipment are connected. The client device 12 is, thus, connected to the equipment via the first network 20.

The embodiment also includes a configuration in which the client device 12 and the equipment are directly connected (e.g., by a universal serial bus (USB) connection). In this case, the first network 20 corresponds to a USB cable. The client device 12 is connected to the equipment directly or via the first network 20.

The equipment executes various types of processing according to instructions from the client device 12. The equipment is a known image forming device, scanner device, facsimile device, or an MFP having multiple functions, for example. The image forming device executes a known image forming function. The scanner device executes a known scanner function that reads images from originals. The facsimile device executes a known facsimile function that transmits and receives data read from originals.

In the embodiment, an exemplary case is described where the type of equipment connected to the first network 20 is the MFP 14. The MFP 14 is a multifunction peripheral that includes multiple functions such as the image forming function, the scanner function, and the facsimile function.

The client device 12 is not connected to a second network 22. The client device 12 is capable of connecting to the equipment and another client device 12 that are connected to the first network 20. The client device 12 is, however, incapable of accessing (connecting to) an external device 18 connected to the second network 22.

The second network 22 is an external network such as the Internet. The equipment connected to the second network 22 performs communication in accordance with a known communication protocol.

The external device 18 is a known computer that stores therein a control program for controlling the MFP 14 (equipment). The external device 18 is a cloud server, for example. The control program for controlling the equipment is a printer driver, a scanner driver, and a facsimile driver when the equipment includes the image forming function, the scanner function, and the facsimile function, respectively, for example. The control program stored in the external device 18 is the latest version. The external device 18 stores therein a driver installer for installing the control program in the client device 12.

The information processing device 16 connects to the client device 12 capable of connecting to the MFP 14 without the networks (the first network 20 and the second network 22). For example, the information processing device 16 connects to the client device 12 capable of connecting to the MFP 14 via universal serial bus (USB) connection. The information processing device 16 performs data communication with the client device 12 on the basis of a USB standard. The information processing device 16 and the client device 12 are connected via the USB connection with a USB cable 24, for example. The USB connection may be established directly between the information processing device 16 and the client device 12.

In the following description, the connection between the information processing device 16 and the client device 12 without the networks (the first network 20 and the second network 22) is simply described as the “USB connection”.

The information processing device 16 connects to the external device 18 via the second network 22. The information processing device 16 communicates with the external device 18 via the second network 22 by wired or wireless communication. The information processing device 16 communicates with the external device 18 via the second network 22 on the basis of a communication standard such as the third generation (3G) or a long term evolution (LTE), for example.

The information processing device 16 is a known personal computer. The information processing device 16 is applicable to the equipment that includes at least the function to establish the USB connection with the client device 12 and the function to connect to the external device 18 via the second network 22. The information processing device 16 is applicable to a mobile terminal such as a smartphone, for example.

The following describes a hardware structure of the client device 12, the information processing device 16, and the external device 18 in the embodiment.

FIG. 2 is a schematic diagram illustrating an example of the hardware structure of the client device 12, the information processing device 16, and the external device 18 in the embodiment.

The client device 12, the information processing device 16, and the external device 18 in the embodiment each include a central processing unit (CPU) 60, a random access memory (RAM) 62, a read only memory (ROM) 64, and an interface (I/F) 66. The CPU 60, the RAM 62, the ROM 64, and the I/F 66 are connected to one another by a bus 72. The hardware is achieved using a typical computer. To the I/F 66, a display 68 such as a known display device and an operation unit 70 that receives the user's various operations are connected.

The display 68 displays various images. The display 68 is a known display device such as a liquid crystal display (LCD) or an organic electroluminescent (EL) display, for example. The operation unit 70 is a member used for the user to input various operations. Examples of the operation unit 70 include a mouse, a button, a remote controller, a keyboard, and a voice recognition device such as a microphone.

The display 68 and the operation unit 70 may be integrated with each other. Specifically, the display 68 and the operation unit 70 may be a touch panel that includes both of an input function and a display function.

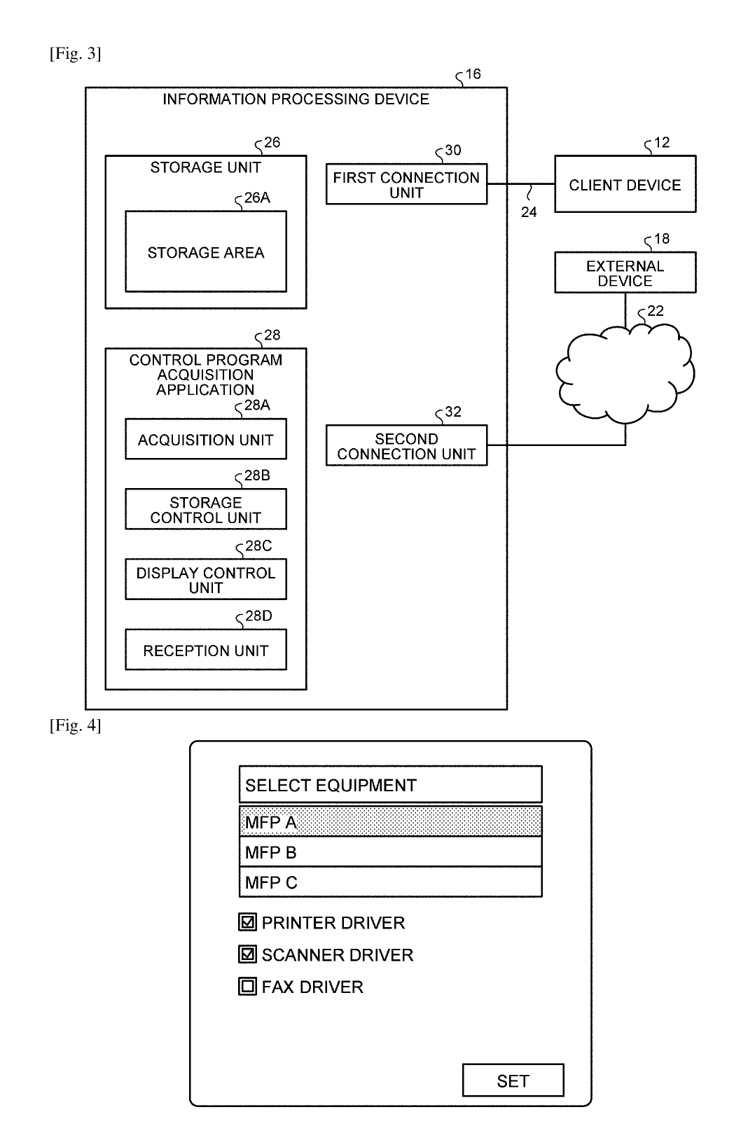

FIG. 3 is a functional block diagram of the information processing device 16.

The information processing device 16 includes a storage unit 26, a control program acquisition application 28, a first connection unit 30, and a second connection unit 32.

The first connection unit 30 is a functional unit for connecting to the client device 12 without the networks (the first network 20 and the second network 22). The first connection unit 30 establishes the USB connection with the client device 12, for example.

In the embodiment, the first connection unit 30 is a communication interface that establishes the USB connection with the client device 12 and performs data communication with the client device 12 on the basis of the USB standard.

The storage unit 26 is a storage area such as an internal memory or a hard disk drive (HDD). The storage unit 26 stores therein various types of data. The storage unit 26 includes at least a storage area 26A. The storage area 26A is a predetermined memory area that is recognized as an external storage device (external storage) by the client device 12 when the USB connection is established with the client device 12 by the first connection unit 30.

When the USB connection is established between the first connection unit 30 and the client device 12, an operating system (OS) preliminarily installed in the information processing device 16 causes the client device 12 to recognize the storage area 26A in the information processing device 16 as the external storage device.

The storage area 26A is the area that functions as the external storage (external storage device). The client device 12 is, thus, capable of accessing the storage area 26A when the USB connection is established between the information processing device 16 and the client device 12 by the first connection unit 30.

The second connection unit 32 is a functional unit that performs data communication with the external device 18 via the second network 22. The second connection unit 32 is a communication interface that performs data communication with the external device 18 via the second network 22, for example.

The control program acquisition application 28 is an application program for acquiring the control program from the external device 18. The control program acquisition application 28 is preliminarily installed in the information processing device 16.

The control program acquisition application 28 includes an acquisition unit 28A, a storage control unit 28B, a display control unit 28C, and a reception unit 28D.

In the embodiment, the acquisition unit 28A, the storage control unit 28B, the display control unit 28C, and the reception unit 28D are loaded and formed in a main storage device when the processor of the information processing device 16 executes the control program acquisition application 28, for example.

The display control unit 28C performs control to display an equipment selection screen and a utilization screen on the display 68 of the information processing device 16.

The equipment selection screen is a screen that causes the user to input at least a type of control program to be downloaded from the external device 18 and an equipment name.

Examples of the type of control program include the printer driver, the scanner driver, and the facsimile driver. The equipment name is the name of the equipment controlled by the control program of the selected type.

The equipment selection screen may allow further selection of a type of language used by the equipment having the equipment name. Examples of the type of language include a refined printing command stream (RPCS) and a page description language (PDL) such as a postscript (PS).

FIG. 4 is a schematic diagram illustrating an example of the equipment selection screen. In the example illustrated in FIG. 4, the information processing device 16 is assumed to have preliminarily stored therein a list of the equipment names that can be acquired from the external device 18. The display control unit 28C displays the equipment selection screen that includes the list of the acquirable equipment names on the display 68 of the information processing device 16. In the example illustrated in FIG. 4, the equipment selection screen displays “MFP A”, “MFP B”, and “MFP C” as the equipment names. The equipment selection screen also includes “printer driver”, “scanner driver”, and “facsimile (FAX) driver” as the types of the control programs.

The user selects, from the list of the equipment names included in the equipment selection screen, the name of the equipment for which the control program is to be downloaded by operating the operation unit 70 of the information processing device 16. The user selects the type of the control program included in the equipment selection screen by operating the operation unit 70 of the information processing device 16. In the example illustrated in FIG. 4, the equipment name “MFP A” and the types of the control programs “printer driver” and “scanner driver” are selected.

The reception unit 28D receives signals indicating various operation instructions from the operation unit 70 of the information processing device 16. The reception unit 28D receives the type of the control program to be downloaded from the external device 18 and the equipment name from the operation unit 70 of the information processing device 16.

The reception unit 28D is not limited to receive, via the equipment selection screen, the equipment name and the type of the control program that are selected by the user from the operation unit 70 of the information processing device 16. For example, the reception unit 28D may acquire the equipment name and the type from the MFP 14 using a known short distance wireless communication technique such as a near field communication (NFC) or a Bluetooth (registered trademark) low energy (BLE) or a known reading technique such as a quick response (QR) (registered trademark) code.

The utilization screen is a screen that prompts the user to read the storage area 26A. The utilization screen includes a message that prompts the USB connection between the information processing device 16 and the client device 12, and a message that prompts the reading of the storage area 26A, for example.

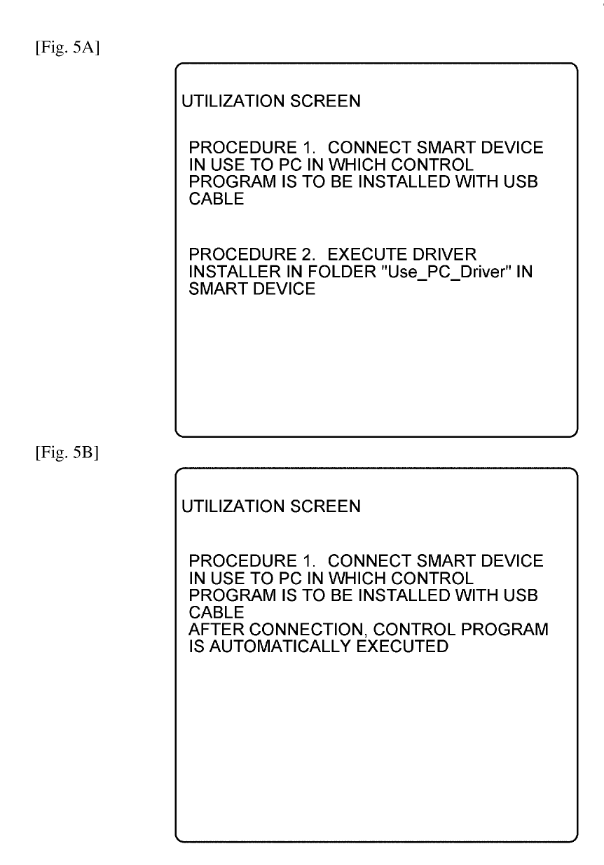

FIGS. 5A and 5B are schematic diagrams illustrating an example of the utilization screen. In the example illustrated in FIG. 5A, the utilization screen includes the message that prompts the USB connection between the information processing device 16 and the client device 12, and the message that prompts the execution of the driver installer stored in the storage area 26A. The driver installer is a program for installing the control program stored in the storage area 26A in the client device 12.

The driver installer stored in the storage area 26A may be automatically (without the user's instruction through the operation) executed by the client device 12 when the USB connection is established between the information processing device 16 and the client device 12. In this case, as illustrated in FIG. 5B, the utilization screen may include a message that prompts the USB connection to be established between the information processing device 16 and the client device 12.

Referring back to FIG. 3, the acquisition unit 28A acquires (downloads) the control program for controlling the MFP 14 from the external device 18 via the second network 22.

Specifically, the acquisition unit 28A acquires, from the reception unit 28D, the equipment name and the type of the control program. The equipment name and the type of the control program are input by the user via the equipment selection screen displayed on the display 68 of the information processing device 16. The acquisition unit 28A downloads (acquires), from the external device 18, the control program of the received type, which is used for controlling the equipment having the equipment name received by the reception unit 28D. At this time, the acquisition unit 28A acquires, from the external device 18, the driver installer for installing the control program in the client device 12 together with the control program.

The storage control unit 28B stores the control program and the driver installer that are acquired by the acquisition unit 28A in the storage area 26A.

For example, the storage control unit 28B stores the control program and the driver installer in a specific folder in the storage area 26A. The specific folder coincides with the area that the display control unit 28C prompts the user to read when displaying the utilization screen (refer to FIG. 5) on the display 68.

FIG. 6 is a schematic diagram illustrating an example of a data structure of the storage area 26A. As a result of the processing by the storage control unit 28B, the control program and the driver installer are stored in the specific folder in the storage area 26A. In the example illustrated in FIG. 6, the printer driver for the MFP A and the scanner driver for the MFP A are stored as the control programs. In the example illustrated in FIG. 6, the specific folder is described with the name “Use_PC_Driver”. The specific folder is, however, not limited to this example.

The storage area 26A is the area that is recognized as the external storage device (external storage) by the client device 12 when the USB connection is established with the client device 12.

When the information processing device 16 is connected to the client device 12 by the first connection unit 30, the display control unit 28C displays the utilization screen that prompts the reading of the storage area 26A on the display 68 of the information processing device 16.

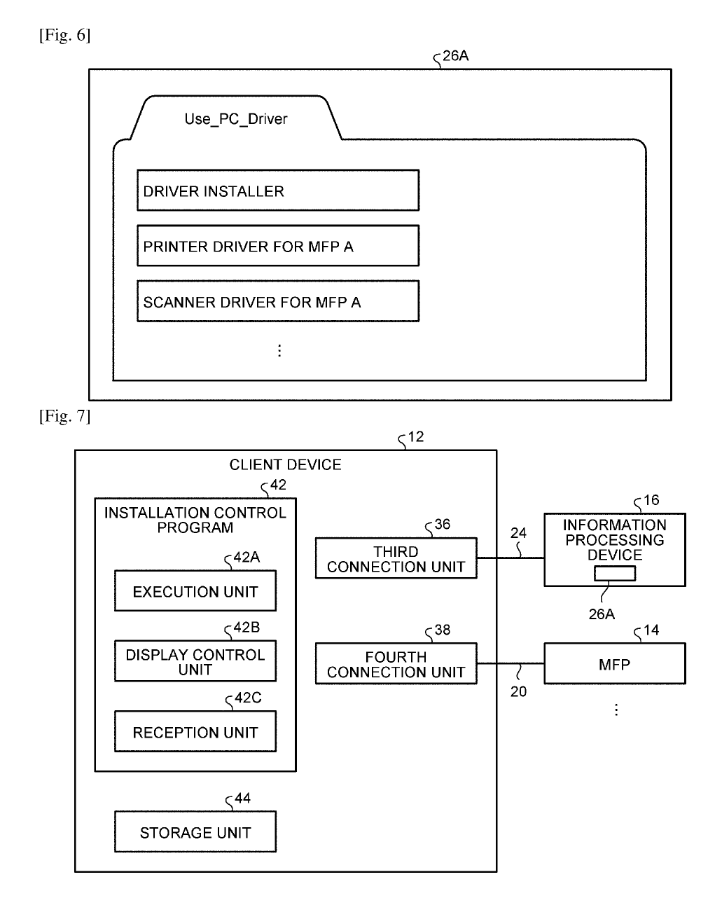

The following describes the client device 12. FIG. 7 is a functional block diagram of the client device 12.

The client device 12 includes an installation control program 42, a storage unit 44, a third connection unit 36, and a fourth connection unit 38.

The third connection unit 36 is a functional unit for connecting to the information processing device 16 without the networks (the first network 20 and the second network 22). In the same manner as described above, in the following description, the connection between the client device 12 and the information processing device 16 without the networks (the first network 20 and the second network 22) is simply described as the “USB connection”. In the embodiment, the USB connection means the connection between the client device 12 and the information processing device 16 without the networks (the first network 20 and the second network 22). The connection using a USB is an example of the USB connection.

In the embodiment, the third connection unit 36 is a communication interface that establishes the USB connection with the information processing device 16 and performs data communication with the information processing device 16 on the basis of the USB standard, for example.

When the USB connection is established between the client device 12 and the information processing device 16 by the third connection unit 36, the client device 12 recognizes the storage area 26A of the information processing device 16 as the external storage device (external storage).

When the USB connection is established between the third connection unit 36 and the information processing device 16, the OS preliminarily installed in the client device 12 recognizes the storage area 26A of the information processing device 16 as the external storage device.

The client device 12 is, thus, capable of accessing the storage area 26A when the USB connection is established between the information processing device 16 and the client device 12 by the third connection unit 36.

The fourth connection unit 38 connects to the MFP 14 via the first network 20. The fourth connection unit 38 is a communication interface that performs data communication with the MFP 14 via the first network 20. The fourth connection unit 38 may directly connect to the MFP 14.

The installation control program 42 is an application program for acquiring the control program, for example, from the information processing device 16. In the embodiment, the installation control program 42 is preliminarily installed in the client device 12.

The installation control program 42 includes an execution unit 42A, a display control unit 42B, and a reception unit 42C. In the embodiment, the execution unit 42A, the display control unit 42B, and the reception unit 42C are loaded and formed in the main storage device when the processor of the client device 12 executes the installation control program 42, for example.

The display control unit 42B performs control to display various screens on the display 68 of the client device 12. The reception unit 42C receives the user's instructions via the operation unit 70 of the client device 12.

When the USB connection is established with the information processing device 16 by the third connection unit 36, the execution unit 42A installs the control program stored in the storage area 26A of the information processing device 16 in the client device 12.

Specifically, when the USB connection is established with the information processing device 16 by the third connection unit 36, the execution unit 42A executes the driver installer stored in the storage area 26A of the information processing device 16. By executing the driver installer, the execution unit 42A installs the control program stored in the storage area 26A in the client device 12.

The execution unit 42A may execute the driver installer stored in the storage area 26A when the USB connection is established with the information processing device 16 by the third connection unit 36, or alternately, the execution unit 42A may execute the driver installer stored in the storage area 26A after waiting for the user's instruction. In the latter case, the execution unit 42A may execute the driver installer so as to install the control program when the execution of the driver installer is instructed by the user by operating the operation unit 70 of the information processing device 16 after the USB connection is established with the information processing device 16.

The installation control program 42 does not control the MFP 14 alone (specifically, an image forming instruction, a scan instruction, and a facsimile transmission instruction, for example). The installation control program 42 controls the MFP 14 via the control program installed in the client device 12. The client device 12 is, thus, capable of controlling the MFP 14 as a result of the installation of the control program in the client device 12. When the control program of an old version is installed in the client device 12, the processing by the execution unit 42A causes the control program of the latest version to be installed.

In the client device 12, identification information on the MFP 14 (identification information in the first network 20) may be set by the user's instruction through the operation of the operation unit 70 of the client device 12.

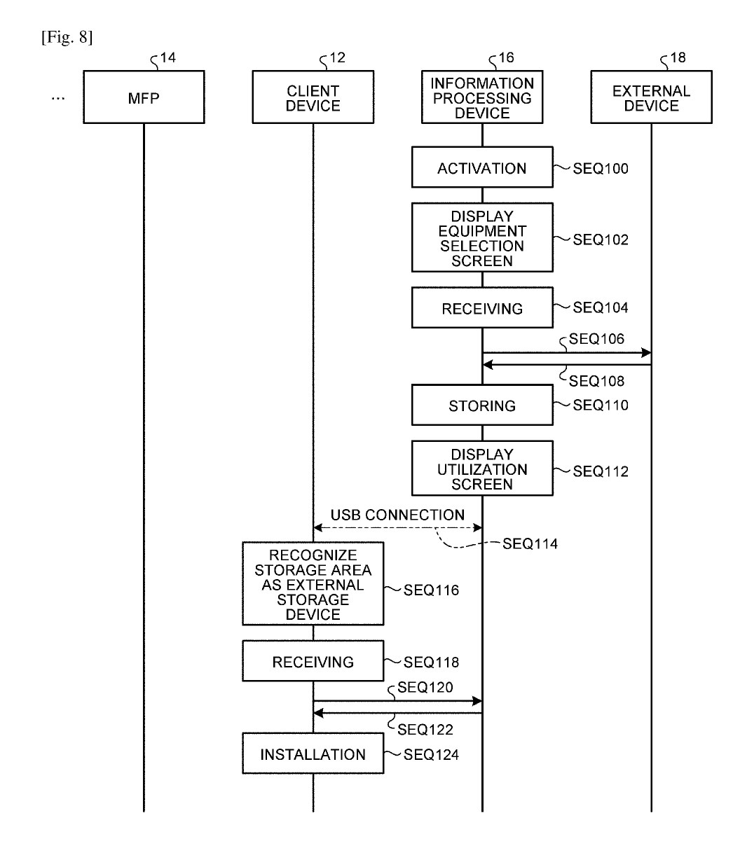

The following describes a procedure of information processing executed by the information processing system 10. FIG. 8 is a sequence diagram illustrating an exemplary procedure of the information processing executed by the information processing system 10.

The information processing device 16 activates the control program acquisition application 28 (SEQ100). As a result of the processing at SEQ100, the acquisition unit 28A, the storage control unit 28B, the display control unit 28C, and the reception unit 28D are loaded and formed in the main storage device.

The display control unit 28C displays the equipment selection screen (refer to FIG. 4) on the display 68 of the information processing device 16 (SEQ102). A user selects the name of the equipment for which the control program is to be downloaded and the type of the control program while referring to the equipment selection screen displayed on the display 68. The reception unit 28D receives, from the operation unit 70 of the information processing device 16, the equipment name and the type of the control program that are selected by the user via the equipment selection screen (SEQ104).

The acquisition unit 28A of the information processing device 16 acquires (downloads), from the external device 18, the control program for controlling the MFP 14 having the equipment name received at SEQ104 and the driver installer (SEQ106 and SEQ108).

The storage control unit 28B stores the control program and the driver installer that are acquired by the acquisition unit 28A in the storage area 26A (SEQ110).

The display control unit 28C displays the utilization screen on the display 68 of the information processing device 16 (SEQ112). The user refers to the utilization screen (refer to FIG. 5) and establishes the USB connection between the client device 12 and the information processing device 16 (SEQ114).

Upon establishment of the USB connection, the client device 12 recognizes the storage area 26A of the information processing device 16 as the external storage device (SEQ116).

The reception unit 42C of the client device 12 receives the instruction to execute the driver installer from the operation unit 70 of the client device 12 (SEQ118).

The execution unit 42A of the client device 12 acquires, from the storage area 26A, the control program stored in the storage area 26A of the information processing device 16 (SEQ120 and SEQ122), and installs the control program in the client device 12 (SEQ124). By executing the driver installer stored in the storage area 26A, the execution unit 42A executes the installation at SEQ124. Then, this sequence ends.

The execution unit 42A may install the control program stored in the storage area 26A of the information processing device 16 using an installer included in the OS of the client device 12 without using the driver installer. The execution unit 42A may execute the processing at SEQ 120, SEQ 122, and SEQ124 without waiting for the execution instruction by the user. In other words, the processing at SEQ118 may be omitted.

As described above, the information processing device 16 in the embodiment connects to the external device 18 via the network (the second network 22). The information processing device 16 includes the first connection unit 30, the acquisition unit 28A, the storage control unit 28B, and the display control unit 28C. The first connection unit 30 connects to the terminal (the client device 12) that is capable of connecting to the equipment (the MFP 14) that performs processing in accordance with a request from the terminal (the client device 12) without the networks (the first network 20 and the second network 22). The acquisition unit 28A acquires the control program for controlling the equipment (the MFP 14) from the external device 18 via the network (the second network 22). The storage control unit 28B stores the control program acquired by the acquisition unit 28A in the predetermined storage area 26A that is recognized as the external storage device by the terminal (the client device 12) connected by the first connection unit 30. When the information processing device 16 is connected to the terminal (the client device 12) by the first connection unit 30, the display control unit 28C displays the utilization screen that prompts the reading of the storage area 26A on the display 68 of the information processing device 16.

The information processing device 16 in the embodiment has an advantage effect of making it possible to readily install the control program for the equipment (the MFP 14) in the terminal (the client device 12) under an environment in which the terminal (the client device 12) is not connected to the external network (the second network 22).

The control program is preferably at least one of the printer driver, the scanner driver, and the facsimile driver.

The client device 12 includes the third connection unit 36, the fourth connection unit 38, and the execution unit 42A. The third connection unit 36 connects to the information processing device 16 without the first network 20 and the second network 22. The fourth connection unit 38 connects to the equipment (the MFP 14) directly or via the first network 20. When the client device 12 is connected to the information processing device 16 by the third connection unit 36, the execution unit 42A installs the control program stored in the storage area 26A in the terminal (the client device 12).

The information processing system 10 in the embodiment can readily install the control program for the equipment (the MFP 14) in the client device 12 under an environment in which the terminal (the client device 12) is not connected to the external network (the second network 22).

First Modification

In the embodiment described above, the storage area 26A of the information processing device 16 has the data structure illustrated in FIG. 6. The data structure of the storage area 26A of the information processing device 16 is, however, not limited to the data structure illustrated in FIG. 6.

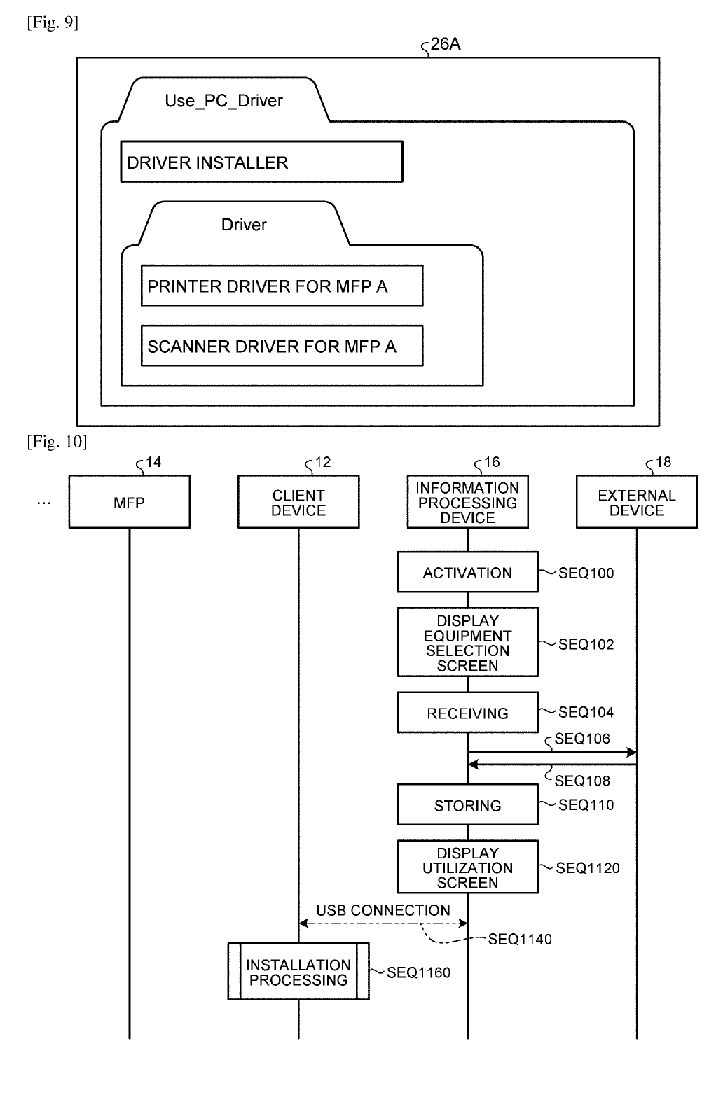

FIG. 9 is a schematic diagram illustrating another example of the data structure of the storage area 26A. The data structure of the storage area 26A may be the structure illustrated in FIG. 9, for example. Specifically, a specific folder “Use_PC_Driver” is formed under the root directory in the storage area 26A. The driver installer is stored in the specific folder “Use_PC_Driver”. In addition, a folder “Driver” is formed in the specific folder “Use_PC_Driver”. The control program is stored in the folder “Driver”.

In the example illustrated in FIG. 9, the printer driver for the MFP A and the scanner driver for the MFP A are stored as the control programs.

In this case, the installation control program 42 of the client device 12 may execute the following processing instead of the processing from SEQ116 to SEQ124 in FIG. 8.

FIG. 10 is a sequence diagram illustrating an exemplary procedure of the information processing executed by the information processing system 10 in the first modification. In the information processing system 10, the processing from SEQ100 to SEQ110 is executed in the same manner as the embodiment described above (refer to FIG. 8).

The display control unit 28C of the information processing device 16 displays the utilization screen on the display 68 of the information processing device 16 (SEQ1120). The user refers to the utilization screen (refer to FIG. 5) and establishes the USB connection between the client device 12 and the information processing device 16 (SEQ1140).

The utilization screen displayed on the display 68 of the information processing device 16 includes the message that prompts the execution of the driver installer stored in the storage area 26A as described with reference to FIG. 5A. The user can select the driver installer by referring to the utilization screen. When a plurality of execution files (executables) are stored in the storage area 26A, it is difficult for the user to identify the driver installer out of the execution files in some cases.

In the first modification, the data structure of the storage area 26A is the structure illustrated in FIG. 9. In the first modification, the execution file stored in the specific folder “Use_PC_Driver” in the storage area 26A is, thus, the driver installer only. As a result, the user can readily find the driver installer from the storage area 26A.

In the first modification, upon establishment of the USB connection at SEQ1140, the installation control program 42 executes the installation processing (SEQ1160).

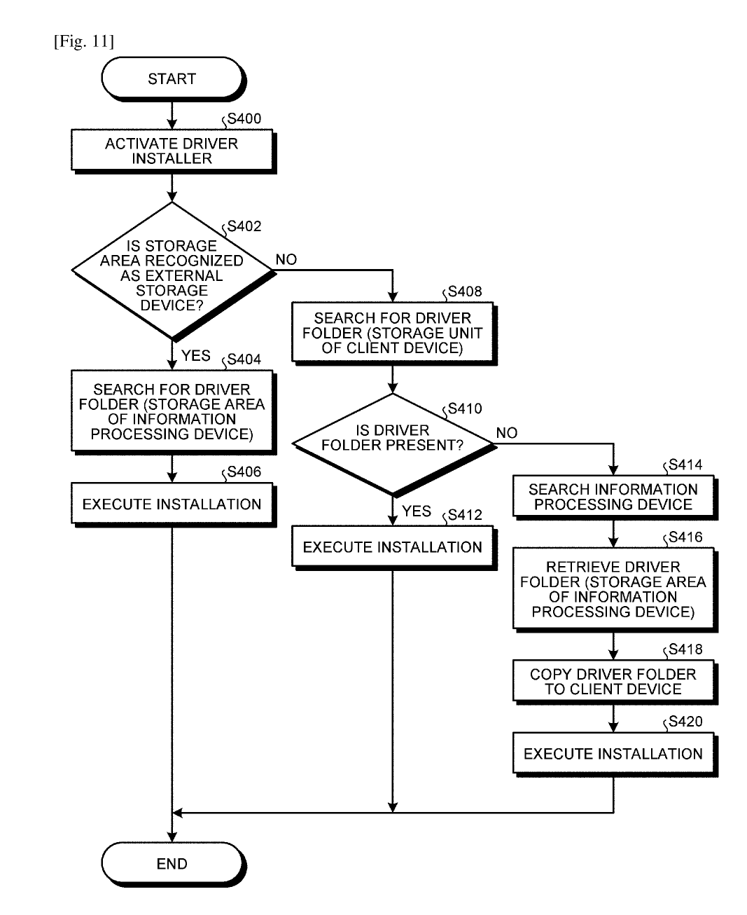

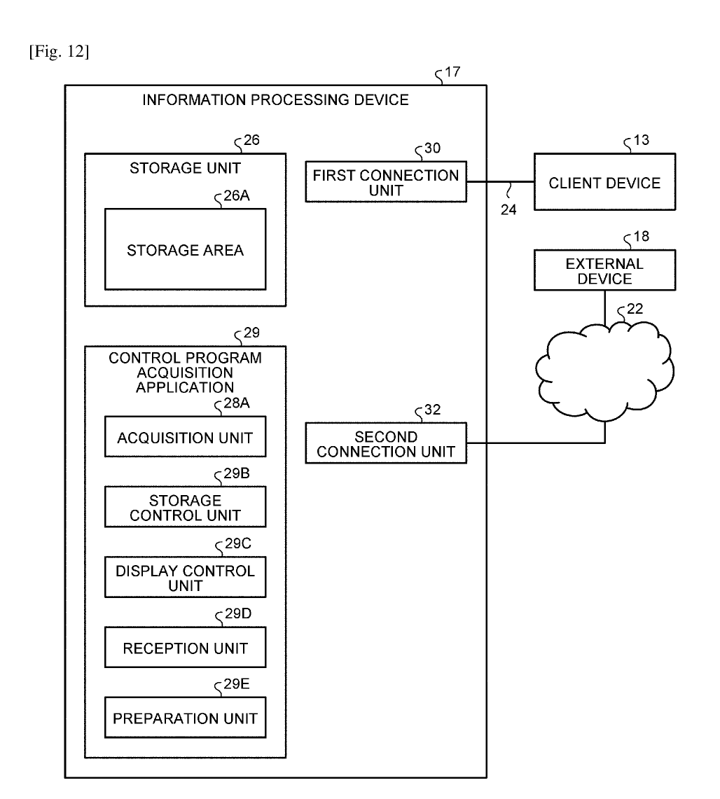

FIG. 11 is a flowchart illustrating an exemplary procedure of the installation processing at SEQ1160.

The execution unit 42A of the installation control program 42 in the client device 12 activates the driver installer stored in the specific folder “Use_PC_Driver” in the storage area 26A (step S400).

Two cases are available in relation to the OS preliminarily installed in the information processing device 16. One is a case where the OS supports the function that causes the client device 12 to recognize the storage area 26A in the information processing device 16 as the external storage device (external storage). The other is a case where the OS supports a media transfer protocol (MTP).

When the OS of the information processing device 16 supports the function of recognition of the external storage device, the storage area 26A in the information processing device 16 is recognized as the external storage device by the client device 12 upon establishment of the USB connection between the client device 12 and the information processing device 16.

When the OS of the information processing device 16 supports the MTP, the client device 12 cannot recognize the storage area 26A of the information processing device 16 as the external storage device when the USB connection is established between the client device 12 and the information processing device 16.

The execution unit 42A, thus, determines whether the client device 12 recognizes the storage area 26A of the information processing device 16, with which the USB connection is established at SEQ1140 (refer to FIG. 10), as the external storage device (step S402).

If the client device 12 recognizes the storage area 26A as the external storage device (Yes at step S402), the processing proceeds to step S404. At step S404, the execution unit 42A retrieves the control program from the folder “Driver” in the specific folder “Use_PC_Driver” in the storage area 26A of the information processing device 16 (step S404).

The execution unit 42A executes the installation of the control program retrieved at step S404 in the client device 12 (step S406). Then, this routine ends.

If the negative determination is made at step S402 (No at step S402), the processing proceeds to step S408. The negative determination is made at step S402 when the OS of the information processing device 16 supports the MTP.

At step S408, the execution unit 42A searches for the folder “Driver” in the storage unit 44 of the client device 12 (step S408).

If the folder “Driver” is present in the storage unit 44 of the client device 12 (Yes at step S410), the processing proceeds to step S412. At step S412, the execution unit 42A installs, in the client device 12, the control program in the folder “Driver” in the storage unit 44 of the client device 12 (step S412). Then, this routine ends.

If the folder “Driver” is absent in the storage unit 44 of the client device 12 (No at step S410), the processing proceeds to step S414. At step S414, the execution unit 42A searches the information processing device 16 (step S414) and retrieves the folder “Driver” from the storage area 26A of the searched information processing device 16 (step S416).

The execution unit 42A copies, to the storage unit 44 of the client device 12, the folder “Driver” retrieved at step S416 together with the control program stored in the folder “Driver” (step S418).

The execution unit 42A installs, in the client device 12, the control program in the folder “Driver” in the storage unit 44 of the client device 12 (step S420). Then, this routine ends.

Although the case where the storage area 26A has the data structure illustrated in FIG. 9 and the execution unit 42A executes the installation processing at SEQ1160, as described above in the first modification, the same advantageous effect can be obtained as the embodiment described above.

As described above, in the first modification, the execution file stored in the specific folder “Use_PC_Driver” in the storage area 26A is the driver installer only. As a result, the user can readily find the driver installer from the storage area 26A.

### Second Embodiment

FIG. 1 is the schematic diagram illustrating an example of an information processing system 11 in a second embodiment of the present invention.

The information processing system 11 includes a client device 13 and an information processing device 17.

The client device 13 is a known personal computer, for example. The client device 13 is connected to the equipment such as the MFP 14 directly or via the first network 20. The first network 20 and the equipment such as the MFP 14 are the same as those in the first embodiment. The client device 13 corresponds to the terminal in the invention.

In the second embodiment, the connection established without the networks (the first network 20 and the second network 22) is also simply described as the “USB connection” in the same manner as the first embodiment.

In the embodiment, an exemplary case is described where the type of the equipment connected to the first network 20 is the MFP 14 in the same manner as the first embodiment.

The client device 13 is not connected to the second network 22. The second network 22 is the same as that in the first embodiment. The external device 18 is connected to the second network 22. The external device 18 is the same as that in the first embodiment.

The USB connection is established between the information processing device 17 and the client device 13. The information processing device 17, thus, performs data communication with the client device 13 on the basis of the USB standard. The USB connection between the information processing device 17 and the client device 13 is established with the USB cable 24 therebetween, for example. The USB connection may be established directly between the information processing device 17 and the client device 13.

The information processing device 17 connects to the external device 18 via the second network 22. The information processing device 17 communicates with the external device 18 via the second network 22 by wired or wireless communication. The information processing device 17 performs data communicates with the external device 18 via the second network 22 on the basis of a communication standard such as 3G or LTE, for example.

The information processing device 17 is a known personal computer. The information processing device 17 is applicable to a mobile terminal such as a smartphone, for example.

FIG. 2 is the schematic diagram illustrating an example of the hardware structure of the client device 13, the information processing device 17, and the external device 18 in the second embodiment.

The client device 13, the information processing device 17, and the external device 18 in the second embodiment each include the CPU 60, the RAM 62, the ROM 64, and the interface (I/F) 66. The CPU 60, the RAM 62, the ROM 64, and the I/F 66 are connected to one another by the bus 72. The hardware is achieved using a typical computer. To the I/F 66, the display 68 such as a known display device and the operation unit 70 that receives the user's various operations are connected.

FIG. 12 is a functional block diagram of the information processing device 17.

The information processing device 17 includes the storage unit 26, a control program acquisition application 29, the first connection unit 30, and the second connection unit 32. The information processing device 17 has the same structure as the information processing device 16 in the first embodiment except for that the information processing device 17 includes the control program acquisition application 29 instead of the control program acquisition application 28.

The control program acquisition application 29 is an application program for acquiring the control program from the external device 18. The control program acquisition application 29 is preliminarily installed in the information processing device 17.

The control program acquisition application 29 includes the acquisition unit 28A, a storage control unit 29B, a display control unit 29C, a reception unit 29D, and a preparation unit 29E.

In the second embodiment, the acquisition unit 28A, the storage control unit 29B, the display control unit 29C, the reception unit 29D, and the preparation unit 29E are loaded and formed in the main storage device when the processor of the information processing device 17 executes the control program acquisition application 29, for example.

The acquisition unit 28A is the same as that in the first embodiment.

The display control unit 29C performs control to display the equipment selection screen and the utilization screen on the display 68 of the information processing device 17. The utilization screen is the same as that in the first embodiment (refer to FIG. 5).

The equipment selection screen is a screen that causes the user to input at least the type of the control program to be downloaded from the external device 18 and the equipment name, in the same manner as the first embodiment.

In the second embodiment, the equipment selection screen further receives the input of identification information on the equipment that is controlled by the control program to be downloaded. The identification information enables the client device 13 to identify the MFP 14 in the first network 20. Specifically, the identification information is an IP address.

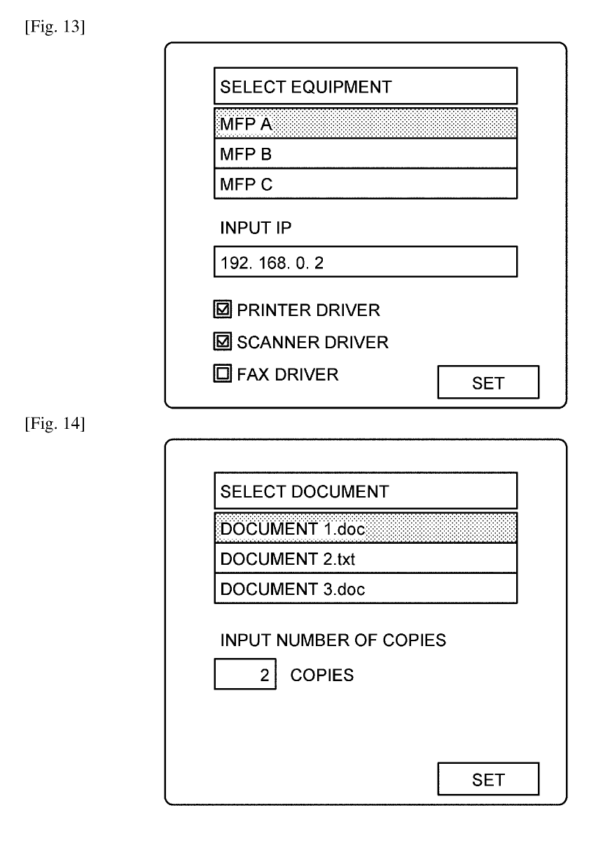

FIG. 13 is a schematic diagram illustrating an example of the equipment selection screen in the second embodiment. In the example illustrated in FIG. 13, the information processing device 17 is assumed to have preliminarily stored therein a list of the equipment names that can be acquired from the external device 18. The display control unit 29C displays the equipment selection screen including the list of the acquirable equipment names on the display 68 of the information processing device 17. In the example illustrated in FIG. 13, the equipment selection screen displays “MFP A”, “MFP B”, and “MFP C” as the equipment names. The equipment selection screen also includes “printer driver”, “scanner driver”, and “facsimile (FAX) driver” as the types of the control programs.

The user selects, by operating the operation unit 70 of the information processing device 17, the name of the equipment for which the control program is to be downloaded from the list of the equipment names included in the equipment selection screen. The user selects the type of the control program included in the equipment selection screen by operating the operation unit 70 of the information processing device 17. In the example illustrated in FIG. 13, the name of the equipment “MFP A” and the types of the control programs “printer driver” and “scanner driver” are selected.

As illustrated in FIG. 13, the equipment selection screen includes the entry field of the IP address serving as the identification information on the MFP 14. The user inputs the identification information on the MFP 14 by operating the operation unit 70 of the information processing device 17.

The operation unit 70 of the information processing device 17 outputs, to the control program acquisition application 29, the equipment name and the type of the control program that are selected via the equipment selection screen by the user, and the identification information on the MFP 14.

Referring back to FIG. 12, the reception unit 29D receives signals indicating various instructions through the operations from the operation unit 70 of the information processing device 17. The reception unit 29D receives the type of the control program to be downloaded from the external device 18, the equipment name, and the input of the identification information on the MFP 14 from the operation unit 70 of the information processing device 17.

In the second embodiment, the display control unit 29C displays, on the display 68 of the information processing device 17, a setting screen that causes the user to input a content to be executed by the MFP 14 identified by the identification information received by the reception unit 29D.

The display control unit 29C displays, on the display 68 of the information processing device 17, the setting screens corresponding to the respective types of the control programs selected by the user. Specifically, examples of the setting screen include an image formation setting screen, a facsimile setting screen, and a scanner setting screen.

The image formation setting screen corresponds to the setting screen for the type “printer driver”. The image formation setting screen causes the user to input the execution content for image formation. The facsimile setting screen corresponds to the setting screen for the type “facsimile driver”. The facsimile setting screen causes the user to input the execution content for facsimile transmission. The scanner setting screen corresponds to the setting screen for the type “scanner driver”. The scanner setting screen causes the user to input the execution content for scanning (image reading).

The display control unit 29C displays the setting screen corresponding to the type of the control program received by the reception unit 29D on the display 68 of the information processing device 17. When the reception unit 29D receives a plurality of types, the display control unit 29C displays sequentially the setting screens corresponding to the received respective types on the display 68 of the information processing device 17.

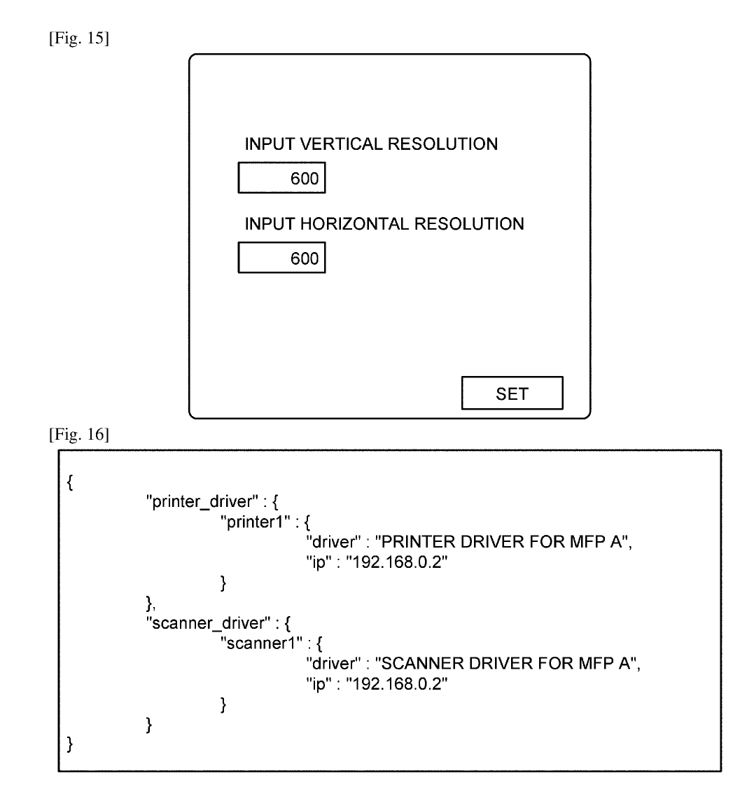

FIGS. 14 and 15 are schematic diagrams illustrating examples of the setting screen. For example, the printer driver and the scanner driver are assumed to be selected as the types of the control programs to be downloaded by the user's instruction through the operation of the operation unit 70 of the information processing device 17.

In this case, the display control unit 29C displays, on the display 68 of the information processing device 17, each of the image formation setting screen corresponding to the type “printer driver” and the scanner setting screen corresponding to the type “scanner driver”.

FIG. 14 is a schematic diagram illustrating an example of the image formation setting screen. For example, the image formation setting screen includes a setting field for a document serving as the image formation target and an entry field for the number of copies in the image formation. In the example illustrated in FIG. 14, “document 1” as the document serving as the image formation target and “2 copies” as the number of copies are input in the image formation setting screen by the user's instruction through the operation of the operation unit 70 of the information processing device 17.

In this case, the reception unit 29D receives “document 1” and “2 copies” as the contents to be executed by the MFP 14 identified by the received identification information when the MFP 14 is caused to execute the image formation function.

FIG. 15 is a schematic diagram illustrating an example of the scanner setting screen. For example, the scanner setting screen includes an entry field for resolution when the image of an original is read. In the example illustrated in FIG. 15, “600” dpi as the vertical resolution and “600” dpi as the horizontal resolution are input in the scanner setting screen by the user's instruction through the operation of the operation unit 70 of the information processing device 17.

In this case, the reception unit 29D receives the vertical resolution “600 dpi” and the horizontal resolution “600 dpi” as the contents to be executed by the MFP 14 identified by the received identification information when the MFP 14 is caused to execute the scanner function.

Referring back to FIG. 12, the preparation unit 29E prepares a first file. The first file is used for setting the control program to be installed in the client device 13. The first file includes the identification information on the MFP 14, which is received by the reception unit 29D. The first file preferably includes the equipment name of the MFP 14 and the identification information (e.g., the IP address of the MFP 14), both of which are received by the reception unit 29D.

The first file may further include option information indicating optional functions included in the MFP 14 the equipment name of which is received by the reception unit 29D and condition information indicating a condition of the MFP 14. The optional function is a finisher function, for example. The optional function is, however, not limited to the finisher function.

FIG. 16 is a schematic diagram illustrating an example of the first file.

For example, the reception unit 29D is assumed to receive the equipment name “MFP A”, the identification information (IP address) “192.168.0.2”, and the types of the control programs “printer driver”, “scanner driver” via the equipment selection screen (refer to FIG. 13). In addition, the reception unit 29D is assumed to receive “document 1” and “2 pieces” via the image formation setting screen, and the vertical resolution “600 dpi” and the horizontal resolution “600 dpi” via the scanner setting screen (refer to FIGS. 14 and 15).

In this case, the preparation unit 29E prepares the first file illustrated in FIG. 16, for example. In the example illustrated in FIG. 16, the IP address serving as the identification information on the MFP 14, the equipment name (e.g., “MFP A”) of the MFP 14, and the types of the control programs are written in the first file in association with one another.

Specifically, in the example illustrated in FIG. 16, the first file is written in a JSON format. The format for the first file is, however, not limited to this format.

In the example illustrated in FIG. 16, the following settings are prepared in the first file: install “printer driver for MFP A” with the name “printer 1” and the connection destination is “192.168.0.2”, and install “scanner driver for MFP A” with the name “scanner1” and the connection destination is “192.168.0.2”.

In the first file illustrated in FIG. 16, the value of “printer_driver” indicates the equipment (practically, the image forming device, which is the MFP 14 in the embodiment) in which the driver (the control program, which is the printer driver in this case) is installed. The value of “driver” indicates the driver to be used (the control program, which is the printer driver in this case). The value of “ip” indicates the identification information (IP address) of the MFP 14.

In the first file illustrated in FIG. 16, the value of “scanner_driver” indicates the equipment (practically, the scanner, which is the MFP 14 in the embodiment) in which the driver (the control program, which is the scanner driver in this case) is installed. The value of “driver” indicates the driver to be used (the control program, which is the scanner driver in this case). The value of “ip” indicates the identification information (IP address) of the MFP 14.

Referring back to FIG. 12, the preparation unit 29E preferably further prepares a second file. The second file represents the processing executed by the control program to be installed in the client device 13. The second file includes the execution contents input by the user via the setting screens described above.

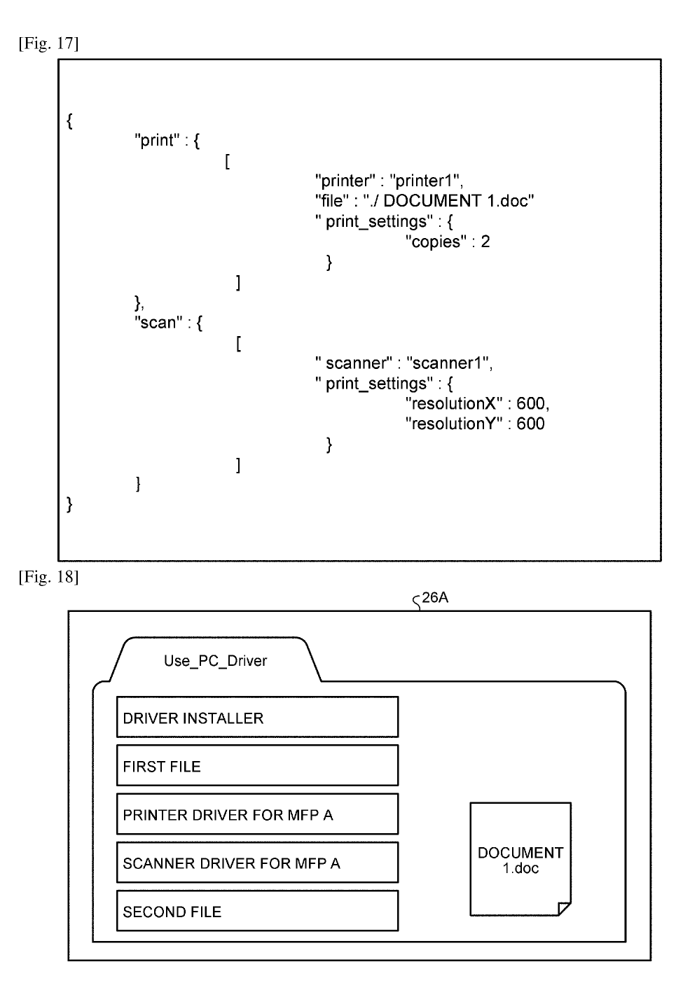

FIG. 17 is a schematic diagram illustrating an example of the second file. In the example illustrated in FIG. 17, the second file is written in a JSON format. The format for the second file is, however, not limited to this format.

In the example illustrated in FIG. 17, the following settings are prepared in the second file: execute image formation of two copies of “document 1.doc” using “printer1” and execute scan with a resolution of 600′600 using scanner1.

In the second file illustrated in FIG. 17, the value of “print” is the definition of the execution content of the image formation. The value of “printer” indicates the equipment (practically, the image forming device, which is the MFP 14 in the embodiment) used for the image formation. The value of “file” indicates a relative path from the second file to the data serving as the image formation target. The value of “print settings” indicates the setting of the image formation. The value of “copies” indicates the number of copies.

In the second file illustrated in FIG. 17, the value of “scan” is the definition of the execution content of the scanner function. The value of “scanner” indicates the equipment (practically, the scanner device, which is the MFP 14 in the embodiment) used for the execution of the scanner function. The value of “print settings” indicates the setting of the scan. The value of “resolutionX” indicates the vertical resolution in scan execution. The value of “resolutionY” indicates the horizontal resolution in scan execution.

Referring back to FIG. 12, the storage control unit 29B stores, in a specific folder in the storage area 26A, the control program and the driver installer that are acquired by the acquisition unit 28A, and the first file and the second file that are prepared by the preparation unit 29E in association with one another. The specific folder is the same as that in the first embodiment.

When the preparation unit 29E does not prepare the second file, the storage control unit 29B may store, in a specific folder in the storage area 26A, the control program and the driver installer that are acquired by the acquisition unit 28A, and the first file prepared by the preparation unit 29E in association with one another.

FIG. 18 is a schematic diagram illustrating an example of the data structure of the storage area 26A in the second embodiment. As a result of the processing by the storage control unit 29B, the driver installer, the control program, the first file, and the second file are stored in the specific folder in the storage area 26A. The storage control unit 29B stores the data (e.g., “document 1”) selected as the image formation target in the storage area 26A.

In the example illustrated in FIG. 18, the printer driver for the MFP A and the scanner driver for the MFP A are selected as the control programs. In the example illustrated in FIG. 18, the specific folder is described with the name “Use_PC_Driver”. The specific folder is, however, not limited to this example.

The storage area 26A is the area that is recognized as the external storage device (external storage) by the client device 13 when the USB connection is established with the client device 13.

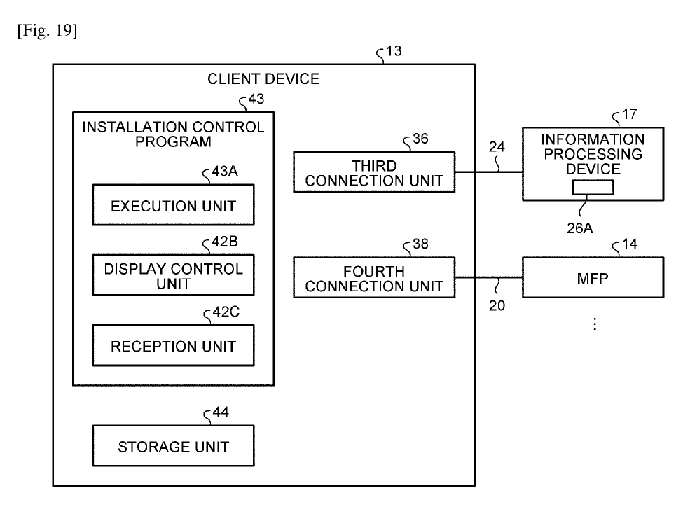

The following describes the client device 13. FIG. 19 is a functional block diagram of the client device 13.

The client device 13 includes an installation control program 43, the storage unit 44, the third connection unit 36, and the fourth connection unit 38.

The client device 13 has the same structure as the client device 12 in the first embodiment except for that the client device 13 includes the installation control program 43 instead of the installation control program 42.

The installation control program 43 is an application program for acquiring the control program, for example, from the information processing device 17. In the second embodiment, the installation control program 43 is preliminarily installed in the client device 13.

The installation control program 43 includes an execution unit 43A, the display control unit 42B, and the reception unit 42C. In the second embodiment, the execution unit 43A, the display control unit 42B, and the reception unit 42C are loaded and formed in the main storage device when the processor of the client device 13 executes the installation control program 43, for example.

The display control unit 42B and the reception unit 42C are the same as those in the first embodiment. When the USB connection is established with the information processing device 17 by the third connection unit 36, the execution unit 43A installs the control program stored in the storage area 26A of the information processing device 17 in the client device 13.

Specifically, when the USB connection is established with the information processing device 17 by the third connection unit 36, the execution unit 43A executes the driver installer stored in the storage area 26A of the information processing device 17. By executing the driver installer, the execution unit 43A installs the control program stored in the storage area 26A in the client device 13.

The installation control program 43 does not control the MFP 14 alone (specifically, the image formation instruction, the scan instruction, and the facsimile transmission instruction, for example). The installation control program 43 controls the MFP 14 via the control program installed in the client device 13. The client device 13 is, thus, capable of controlling the MFP 14 as a result of the installation of the control program in the client device 13. When the control program of an old version is installed in the client device 13, the processing by the execution unit 43A causes the control program of the latest version to be installed.

The execution unit 43A may execute the driver installer stored in the storage area 26A when the USB connection is established with the information processing device 17 by the third connection unit 36 or after waiting for the user's instruction. In the latter case, the execution unit 43A may execute the driver installer so as to install the control program when the execution of the driver installer is instructed by the user by operating the operation unit 70 of the client device 13 after the USB connection is established with the information processing device 17.

In the second embodiment, the execution unit 43A further sets the identification information on the equipment (the MFP 14) on the basis of the first file. Specifically, the execution unit 43A sets the IP address, which is the identification information on the MFP 14 and written in the first file, as the location in the first network 20 of the MFP 14 controlled by the installed control program. This setting makes it possible for the client device 13 and the MFP 14 to be connected via the first network 20 in a communicable manner.

When the first file further includes the option information and the condition information, the execution unit 43A preferably installs the control program by reflecting the option information and the condition information.

After the setting, the execution unit 43A further causes the equipment (the MFP 14) identified by the identification information (IP address) to execute the execution content indicated in the second file.

For example, the execution unit 43A sends the image formation instruction, the scan instruction, or the facsimile transmission instruction to an application in accordance with the content of the second file stored in the folder “Use_PC_Driver” in the storage area 26A. When receiving the instruction, the application sends the image formation instruction, the scan instruction, or the facsimile transmission instruction to the MFP 14 using the installed control program.

At the time, the execution unit 43A controls the MFP 14 such that the MFP 14 executes the execution content indicated in the second file stored in the folder “Use_PC_Driver” in the storage area 26A.

For example, the second file illustrated in FIG. 17 is assumed to be stored in the folder “Use_PC_Driver” in the storage area 26A. In this case, the execution unit 43A reads the extension (“doc”) of the file (“document 1”) serving as the image formation target, for example. The execution unit 43A activates the application capable of executing the file having the extension. For example, the execution unit 43A opens the document 1.doc using Microsoft Word. In the second file, no file is written that is used for the execution of the scanner function. The execution unit 43A, thus, activates an application capable of executing the scanner function.

The execution unit 43A displays, on the display 68 of the client device 13, the screen displayed when the activated application is executed. The execution unit 43A causes the application to execute the execution content indicated in the second file. For example, the execution unit 43A displays a print screen on the display 68 of the client device 13, selects printer1, sets the number of copies to two, and causes the MFP 14 to execute the image formation.

The following describes a procedure of information processing executed by the information processing system 12.

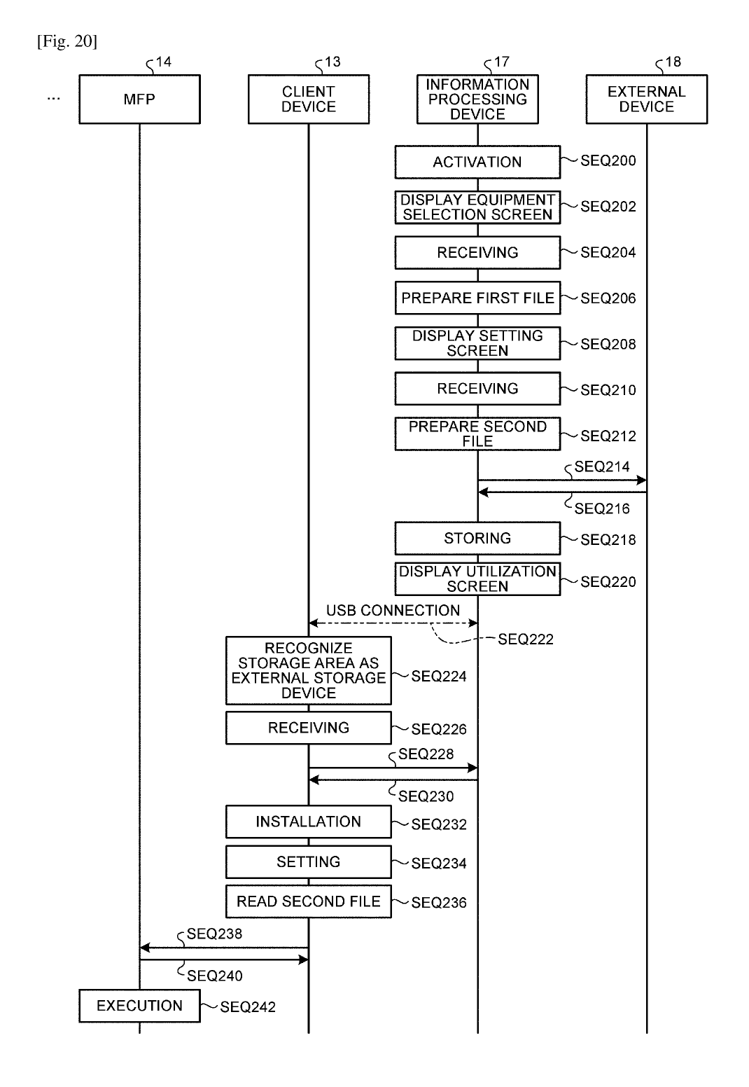

FIG. 20 is a sequence diagram illustrating an exemplary procedure of the information processing executed by the information processing system 12.

The information processing device 17 activates the control program acquisition application (SEQ200). As a result of the processing at SEQ200, the acquisition unit 28A, the storage control unit 29B, the display control unit 29C, the reception unit 29D, and the preparation unit 29E are loaded and formed in the main storage device.

The display control unit 29C displays the equipment selection screen (refer to FIG. 13) on the display 68 of the information processing device 17 (SEQ202). The user selects the name of the equipment for which the control program is to be downloaded, the type of the control program, and the identification information (IP address) about the MFP 14 (equipment) while referring to the equipment selection screen displayed on the display 68. The reception unit 29D receives, from the operation unit 70 of the information processing device 17, the equipment name, the type of the control program, and the identification information on the MFP 14 that are selected by the user via the equipment selection screen (SEQ204).

The preparation unit 29E prepares the first file that includes the equipment name, the identification information, and the type of the control program that are received at SEQ204 (SEQ206).

The display control unit 29C displays the setting screens corresponding to the respective types of the control programs received at SEQ204 on the display 68 of the information processing device 17 (SEQ208).

The reception unit 29D receives the execution contents that are input via the setting screens, which are displayed at SEQ208, corresponding to the respective types of the control programs (SEQ210).

The preparation unit 29E prepares the second file that includes the execution contents received at SEQ210 (SEQ212).

The acquisition unit 28A of the information processing device 17 acquires (downloads), from the external device 18, the control program for controlling the MFP 14 having the equipment name received at SEQ204 and the driver installer (SEQ214 and SEQ216).

The storage control unit 29B stores the control program and the driver installer that are acquired by the acquisition unit 28A in the storage area 26A (SEQ218). At SEQ218, the storage control unit 29B also stores the first file prepared at SEQ206 and the second file prepared at SEQ212 in the storage area 26A.

The display control unit 29C displays the utilization screen on the display 68 of the information processing device 17 (SEQ220). The user refers to the utilization screen (refer to FIG. 5) and establishes the USB connection between the client device 13 and the information processing device 17 (SEQ222).

Upon establishment of the USB connection, the client device 13 recognizes the storage area 26A of the information processing device 17 as the external storage device (SEQ224).

The reception unit 42C of the client device 13 receives the instruction to execute the driver installer from the operation unit 70 of the client device 13 (SEQ226). The processing at SEQ226 may be omitted in the same manner as the first embodiment.

The execution unit 43A of the client device 13 acquires, from the storage area 26A, the control program, the first file, and the second file that are stored in the storage area 26A of the information processing device 17 (SEQ228 and SEQ230). The execution unit 43A installs the acquired control program in the client device 13 (SEQ232). The execution unit 43A executes the installation by executing the driver installer stored in the storage area 26A, for example.

The execution unit 43A sets the identification information on the equipment (the MFP 14) on the basis of the first file acquired at SEQ230 (SEQ234). Specifically, the execution unit 43A sets the IP address, which is the identification information on the MFP 14 and written in the first file, as the location in the first network 20 of the MFP 14 controlled by the installed control program. This setting makes it possible for the client device 13 and the MFP 14 to be connected via the first network 20 in a communicable manner.

The execution unit 43A reads the second file (SEQ236).

The execution unit 43A causes the equipment (the MFP 14) identified by the identification information (IP address) to execute the execution content indicated in the second file (SEQ238 and SEQ240).

The MFP 14 executes the instructed execution content under the control of the client device 13 (SEQ242). When the execution content of the scanner function is included in the second file, the MFP 14 executes the scanner function in accordance with the second file. When the execution content of the image formation is included in the second file, the MFP 14 executes the image formation in accordance with the second file. When the execution content of the facsimile function is included in the second file, the MFP 14 executes the facsimile transmission in accordance with the second file. Then, this routine ends.

As described above, the information processing device 17 in the second embodiment includes the first connection unit 30, the second connection unit 32, the storage unit 26, the acquisition unit 28A, the storage control unit 29B, the display control unit 29C, the reception unit 29D, and the preparation unit 29E. The first connection unit 30 connects to the terminal (the client device 13) that is capable of connecting to the equipment (the MFP 14) that performs processing in accordance with a request from the terminal (the client device 13) without the networks (the first network 20 and the second network 22). The acquisition unit 28A acquires the control program for controlling the equipment (the MFP 14) from the external device 18 via the network (the second network 22). The storage control unit 29B stores the control program acquired by the acquisition unit 28A in the predetermined storage area 26A that is recognized as the external storage device by the terminal (the client device 13) connected by the first connection unit 30. When the information processing device 17 is connected to the terminal (the client device 13) by the first connection unit 30, the display control unit 29C displays the utilization screen that prompts the reading of the storage area 26A on the display 68 of the information processing device 17. The reception unit 29D receives the input of the identification information on the equipment (the MFP 14) controlled by the control program. The preparation unit 29E prepares the first file that includes the received identification information. The storage control unit 29B stores the acquired control program and the first file in the storage area 26A in association with each other.

When the client device 13 is connected to the information processing device 17 by the third connection unit 36, the execution unit 43A of the terminal (the client device 13) installs the control program stored in the storage area 26A in the terminal (the client device 13), and further sets the identification information on the equipment (the MFP 14) on the basis of the first file.

The information processing system 11 in the embodiment, thus, can readily execute the setting of the control program installed in the terminal (the client device 13) without the user's input using the terminal (the client device 13), in addition to the advantageous effect of the first embodiment.

In the information processing system 11 in the second embodiment, the preparation unit 29E of the information processing device 17 preferably further receives the input of the execution content executed by the equipment (the MFP 14) identified by the received identification information. In this case, the preparation unit 29E prepares the second file that includes the received execution content. The storage control unit 29B stores the acquired control program, the first file, and the second file in the storage area 26A in association with one another. When the client device 13 is connected to the information processing device 17 by the third connection unit 36, the execution unit 43A of the terminal (the client device 13) installs the control program in the terminal (the client device 13), and further sets the identification information on the equipment (the MFP 14) on the basis of the first file, and thereafter causes the equipment (the MFP 14) identified by the identification information to execute the execution content indicated in the second file.

The information processing system 11 in the embodiment, thus, can readily control the MFP 14 using the control program installed in the terminal (the client device 13) without the user's input using the terminal (the client device 13), in addition to the advantageous effect of the first embodiment.

Second Modification

In the second embodiment, when the reception unit 42C of the client device 13 receives the instruction to execute the driver installer from the operation unit 70 of the client device 13, the driver installer is executed and the control program is installed in the client device 13.

The installation of the control program may be executed in the client device 13 without waiting for the user's instruction through the operation of the operation unit 70.

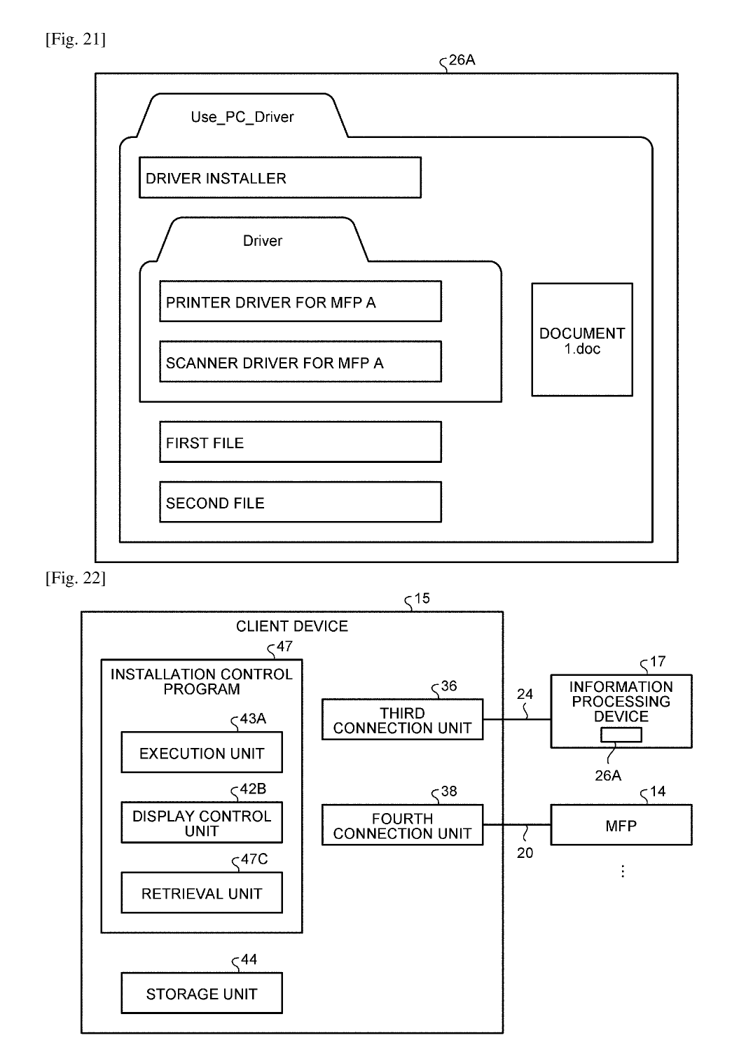

In this case, the data structure of the storage area 26A of the information processing device 17 is preferably the structure illustrated in FIG. 21. FIG. 21 is a schematic diagram illustrating another example of the data structure of the storage area 26A. Specifically, the specific folder “Use_PC_Driver” is formed under the root directory in the storage area 26A. The driver installer, the first file, and the second file are stored in the specific folder “Use_PC_Driver”. In addition, the folder “Driver” is formed in the specific folder “Use_PC_Driver”. The control programs are stored in the folder “Driver”.

In the example illustrated in FIG. 21, the printer driver for the MFP A and the scanner driver for the MFP A are stored as the control programs.

FIG. 1 is the schematic diagram illustrating an example of an information processing system 11A in the second modification. The information processing system 11A includes a client device 15 and the information processing device 17.

The client device 15 is a known personal computer, for example. The client device 15 is connected to the equipment such as the MFP 14 directly or via the first network 20. The first network 20 and the equipment such as the MFP 14 are the same as those in the first embodiment. The client device 15 corresponds to the terminal in the invention.

In the second modification, the connection established without the networks (the first network 20 and the second network 22) is also simply described as the “USB connection” in the same manner as the first embodiment.

The client device 15 is not connected to the second network 22. The second network 22 is the same as that in the first embodiment. The external device 18 is connected to the second network 22. The external device 18 is the same as that in the first embodiment.

The information processing device 17 is the same as that in the second embodiment except for that the data structure of the storage area 26A is the structure illustrated in FIG. 21.

FIG. 2 is the schematic diagram illustrating an example of the hardware structure of the client device 15 in the second modification.

The client device 15 in the second modification includes the CPU 60, the RAM 62, the ROM 64, and the I/F 66. The CPU 60, the RAM 62, the ROM 64, and the I/F 66 are connected to one another by the bus 72. To the I/F 66, the display 68 such as a known display device and the operation unit 70 that receives the user's various operations are connected.

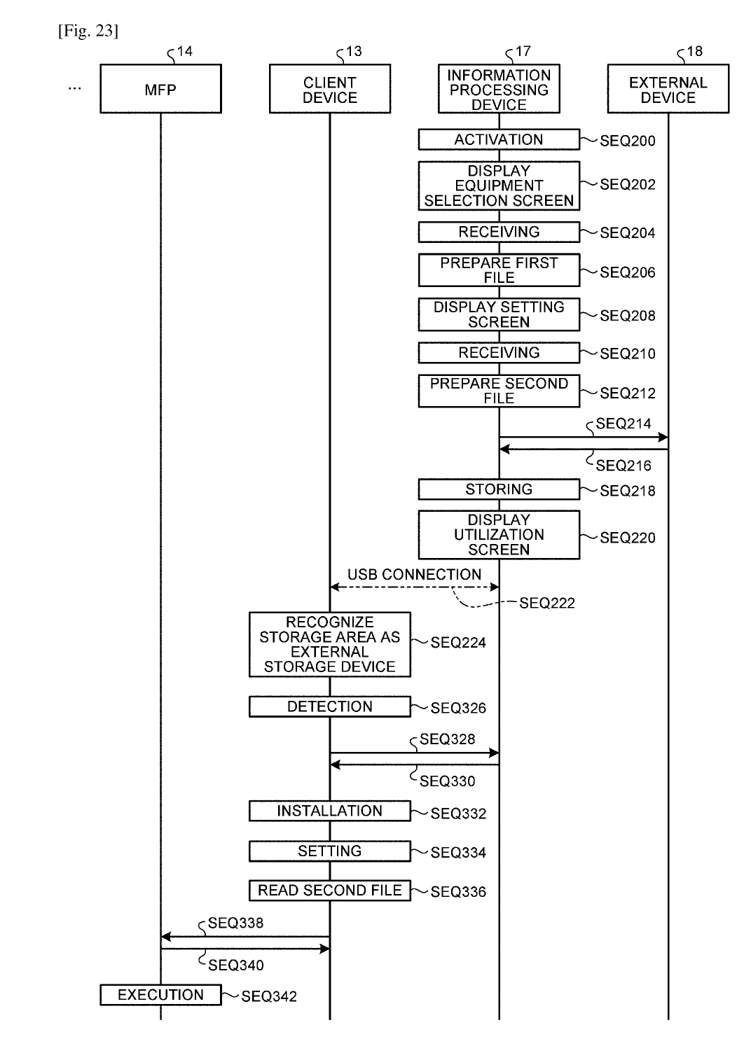

FIG. 22 is a functional block diagram of the client device 15. The client device 15 includes an installation control program 47, the storage unit 44, the third connection unit 36, and the fourth connection unit 38.

The client device 15 has the same structure as the client device 13 in the second embodiment except for that the client device 15 includes the installation control program 47 instead of the installation control program 43.

The installation control program 47 is an application program for acquiring the control program, for example, from the information processing device 17. In the second modification, the installation control program 47 is preliminarily installed in the client device 15.

The installation control program 47 includes the execution unit 43A, the display control unit 42B, and a retrieval unit 47C. In the second modification, the execution unit 43A, the display control unit 42B, and the retrieval unit 47C are loaded and formed in the main storage device when the processor of the client device 15 executes the installation control program 47, for example.

The execution unit 43A and the display control unit 42B are the same as those in the second embodiment. The retrieval unit 47C detects that the USB connection is established between the client device 15 and the information processing device 17. Upon detecting the USB connection, the retrieval unit 47C searches for the specific folder “Use_PC_Driver” in the storage area 26A. The retrieval unit 47C may search for the folder name “Use_PC_Driver” of the specific folder. The retrieval unit 47C retrieves the control program, the first file, and the second file in the specific folder “Use_PC_Driver”.

The execution unit 43A may install the control program retrieved by the retrieval unit 47C in the client device 15. The execution unit 43A may set the identification information on the equipment (the MFP 14) on the basis of the first file, and cause the equipment (the MFP 14) identified by the identification information (IP address) to execute the execution content indicated in the second file.

The following describes a procedure of the information processing executed by the information processing system 11A.

FIG. 23 is a sequence diagram illustrating an exemplary procedure of the information processing executed by the information processing system 11A.

The information processing device 17 performs the processing from SEQ200 to SEQ220 in the same manner as the second embodiment. The user refers to the utilization screen (refer to FIG. 5) and establishes the USB connection between the client device 15 and the information processing device 17 (SEQ222).

Upon establishment of the USB connection, the client device 13 recognizes the storage area 26A of the information processing device 17 as the external storage device (SEQ224).

When detecting that the USB connection is established between the client device 15 and the information processing device 17 (SEQ326), the retrieval unit 47C searches for the specific folder “Use_PC_Driver” in the storage area 26A. The retrieval unit 47C may search for the folder name “Use_PC_Driver” of the specific folder. The retrieval unit 47C retrieves the control program, the first file, and the second file in the specific folder “Use_PC_Driver” (SEQ328 to SEQ330).

The execution unit 43A installs the control program retrieved by the retrieval unit 47C in the client device 15 (SEQ332). The execution unit 43A executes the installation by executing the driver installer stored in the storage area 26A, for example.

The execution unit 43A sets the identification information on the equipment (the MFP 14) on the basis of the first file retrieved from SEQ328 to SEQ330 (SEQ334). Specifically, the execution unit 43A sets the IP address, which is the identification information on the MFP 14 and written in the first file, as the location in the first network 20 of the MFP 14 controlled by the installed control program. This setting makes it possible for the client device 15 and the MFP 14 to be connected via the first network 20 in a communicable manner.

The execution unit 43A reads the second file retrieved from SEQ328 to SEQ330 (SEQ336). The execution unit 43A causes the equipment (the MFP 14) identified by the identification information (IP address) to execute the execution content indicated in the second file (SEQ338 and SEQ340). The MFP 14 executes the instructed execution content under the control of the client device 13 (SEQ342).

The second modification can also obtain the same advantageous effect as the second embodiment.

In the second modification, the installation of the control program can be executed in the client device 15 without waiting for the user's instruction through the operation of the operation unit 70.

The programs to achieve the various types of processing executed by the client devices 12, 13, and 15, and the information processing devices 16 and 17, and the external device 18 in the embodiments and the modifications are embedded and provided in the ROM, for example.

The programs to achieve the various types of processing executed by the client devices 12, 13 and 15, and the information processing devices 16 and 17, and the external device 18 in the embodiments and the modifications may be recorded and provided in a non-transitory computer-readable recording medium such as a compact disc read only memory (CD-ROM), a flexible disk (FD), a compact disc recordable (CD-R), and a digital versatile disc (DVD), as an installable or executable file.

The programs to achieve the various types of processing executed by the client devices 12,13, and 15, and the information processing devices 16 and 17, and the external device 18 in the embodiments and the modifications may be stored in a computer connected to a network such as the Internet, and be provided by being downloaded via the network. The programs to achieve the various types of processing executed by the client devices 12,13, and 15, and the information processing devices 16 and 17, and the external device 18 in the embodiments and the modifications may be stored in a computer connected to a network such as the Internet, and be provided or distributed via the network.

The programs to achieve the various types of processing executed by the client devices 12, 13, and 15, and the information processing devices 16 and 17, and the external device 18 in the embodiments and the modifications have the module structures that include the respective units described above. In real hardware, the CPU reads out the program from the ROM and executes the program, so that the respective units are loaded into the main storage unit, and the respective units are formed in the main storage unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### REFERENCE SIGNS LIST

10, 11, 11A Information processing system
12, 13, 15 Client device
16, 17 Information processing device
18 External device
20 First network
22 Second network
26 Storage unit
26A Storage area
28B, 29B Storage control unit
28C, 29C Display control unit
28D, 29D Reception unit
29E Preparation unit
30 First connection unit
32 Second connection unit
36 Third connection unit
38 Fourth connection unit
42A Execution unit
42C Reception unit
68 Display

### CITATION LIST

### Patent Literature

PTL 1: Japanese Laid-open Patent Publication No. 2008-130060

1. An information processing device that connects to an external device via a network, the information processing device comprising:
a first connection unit configured to connect to, without the network, a terminal capable of connecting to equipment that executes processing in accordance with a request from the terminal;
an acquisition unit configured to acquire a control program for controlling the equipment from the external device via the network;
a storage control unit configured to store the control program acquired by the acquisition unit in a predetermined storage area that is recognized as an external storage device by the terminal connected by the first connection unit; and
a display control unit configured to display, on a display unit, a utilization screen that prompts reading of the storage area when the information processing device is connected to the terminal by the first connection unit.

2. The information processing device according to claim 1, wherein the control program is at least one of a printer driver, a scanner driver, and a facsimile driver.

3. A non-transitory computer-readable recording medium that contains a computer program that causes a computer connecting to an external device via a network and including a first connection unit connecting to, without the network, a terminal capable of connecting to equipment that executes processing in accordance with a request from the terminal, to execute:
acquiring a control program for controlling the equipment from the external device via the network;
storing the control program acquired by the acquisition unit in a predetermined storage area that is recognized as an external storage device by the terminal connected by the first connection unit; and
displaying, on a display unit, a utilization screen that prompts reading of the storage area when the computer is connected to the terminal by the first connection unit.

4. An information processing system comprising:
an information processing device connecting to an external device via a second network; and
a terminal capable of connecting to, directly or via a first network, equipment that executes processing in accordance with a request from the terminal, wherein
the information processing device includes:
a first connection unit configured to connect to the terminal capable of connecting to the equipment without the first network or the second network;
an acquisition unit configured to acquire a control program for controlling the equipment from the external device via the second network;
a storage control unit configured to store the control program acquired by the acquisition unit in a predetermined storage area that is recognized as an external storage device by the terminal connected by the first connection unit; and
a display control unit configured to display, on a display unit, a utilization screen that prompts reading of the storage area when the information processing device is connected to the terminal by the first connection unit, and
the terminal includes:
a third connection unit configured to connect to the information processing device without the first network or the second network;
a fourth connection unit configured to connect to the equipment directly or via the first network; and
an execution unit configured to install, in the terminal, the control program stored in the storage area when the terminal is connected to the information processing device by the third connection unit.

5. The information processing system according to claim 4, wherein the information processing device further includes:
a reception unit configured to receive input of identification information on the equipment controlled by the control program; and
a preparation unit configured to prepare a first file that includes the received identification information,
the storage control unit stores the acquired control program and the first file in the storage area, and
the execution unit installs, in the terminal, the control program stored in the storage area when the terminal is connected to the information processing device by the third connection unit, and further sets the identification information on the equipment on the basis of the first file.

6. The information processing system according to claim 5, wherein the reception unit further receives input of an execution content to be executed by the equipment identified by the received identification information,
the preparation unit further prepares a second file that includes the received execution content,
the storage control unit stores the acquired control program, the first file, and the second file in the storage area, and
the execution unit installs the control program in the terminal when the terminal is connected to the information processing device by the third connection unit, and further sets the identification information on the equipment on the basis of the first file, and then causes the equipment identified by the identification information to execute the execution content indicated in the second file.
